(19) United States
(12) Patent Application Publication
(10) Pub. No.: US 2008/0199371 A1
(43) Pub. Date: Aug. 21, 2008

(54) Microfluidic Device for Patterned Surface Modification

(76) Inventors: Janos Voros, Zurich (CH); Marc Dusseiller, Zurich (CH); Brigitte Niederberger, Thalwil (CH); Marcus Textor, Schaffhausen (CH)

Correspondence Address: Richard F. Jaworski;c/o Cooper & Dunham, 1185 Avenue of the Americas, New York, NY, 10036, US

(21) Appl. No.: 11/667,204

(22) PCT Filed: Nov. 12, 2004
(86) PCT No.: PCT/CH2004/000687

§ 371 Date: Dec. 12, 2007

(51) Int. Cl. B01J 10/00

(52) U.S. Cl. 422/188; 156/60

(57) ABSTRACT

A microfluidic device and its use for the production of micro-arrays, in particular for the detection of protein interactions, is described. Said microfluidic device comprises a flow cell part (1) and a chip part (2) together forming at least two crossing, preferably perpendicular, closed channels (3, 4), said flow cell part forming open channels providing the bottom wall and at least part of the side walls, in particular three walls of said closed channels (3, 4), said closed channels (3, 4) being connected to at least three fluid providing means for generating at least three fluid flows (7) and said closed channels (3, 4) being designed and dimensioned such that the flow of at least three aqueous fluids streaming through each of said channels (3, 4) is laminar at least until after said crossing of said channels (6), said chip part (2) forming the top wall and optionally part of said side walls, in particular the fourth wall, of said closed channels (3, 4) and having a surface that is activatable by reaction with an activating molecule.

### TECHNICAL FIELD

The present invention concerns a microfluidic device, a method for its production and its use for patterned surface modification, in particular by area specific protein adsorption.

### BACKGROUND ART

Microfluidic devices are known. Already in the 1970s the first microfluidic device was constructed at Stanford University. The growth of interest in molecular biology, especially genomics, in the following years has stimulated the development of technology for the analysis of complex mixtures of macromolecules as for example DNA and proteins in aqueous solutions by capillary electrophoresis (CE). The benefits of microfluidic devices are diverse: They offer a decrease in the costs of manufacture, use and disposal as well as a reduction in analysis time. By use of microfluidic devices the consumption of reagents and analytes is reduced and separation efficiency and portability are increased. These early systems were manufactured by technology derived from microelectronics as photolithography and etching in silicon and glass. The disadvantages of this technology consists in the use of relatively expensive materials, and the requirement of high temperature or voltage for the sealing led to a rapid development of new production technologies with new materials. The advantage of these new materials, all polymers, are the low price, the possibility of production by molding or embossing and that they can be sealed thermally or by adhesives [1]. Among these polymers polydimethylsiloxane (PDMS) became most prominent. It is optically transparent, non-toxic, commercially available and its hydrophobic surface can easily be converted to hydrophilic. Furthermore it has a Young's modulus that makes it a moderately stiff elastomer [2]. Nevertheless PDMS shows the disadvantage of being incompatible with organic solutions [3]. Standard techniques for the production of microfluidic devices include micromachining, soft lithography, embossing, in situ construction, injection molding and laser ablation [4-9]. Nowadays microfluidic devices are used in biology for DNA analysis [2], cell sorting [10], as biosensors [1], as devices for cell culturing [11] and as devices for cell and protein patterning [12, 13].

Protein patterning is performed on so called protein arrays where proteins are immobilized on well defined areas for quantification or functional analysis [14, 15]. One type of surfaces on which proteins can be immobilized are surfaces with a high inherent binding energy to proteins in general [16]. The most common of these substrates are hydrophobic plastics to which most proteins adsorb physically by van der Waals, hydrophobic and hydrogen-bonding interactions. The disadvantages of these adsorption mechanisms are that the immobilized proteins build clusters on the surface and that most of them denature and thus lose their functionality. Therefore protein immobilization is preferably performed on surfaces, which offer specific binding sites for certain proteins. Examples for such binding mechanisms are biotinylated proteins that bind to streptavidin-coated surfaces or His-tagged proteins binding to Ni²⁺-chelating surfaces. These binding sites are situated on well defined areas surrounded by protein resistant surfaces to prevent non specific adsorption. The detection of immobilized proteins is mainly performed by fluorescence using charge-coupled device (CCD) cameras or laser scanners with confocal detection optics. Furthermore radioactivity, chemiluminescence or label-free plasmon-resonance based detection systems can be used [14].

The first method of printing proteins onto surfaces was using instruments designed for DNA spotting [16, 17]. Due to long printing times coupled with small volumes which are spotted onto the surfaces this method generally leads to drying of the protein spot. Therefore other printing methods as deposition by a hydrogel stamp inked with an aqueous protein solution [18], inkjet printing [19], electrospray through a dielectric grid mask [20] and direct application of protein solutions via microfluidic networks [12, 21] were developed, to keep the proteins hydrated during the experiment.

In the hitherto known microfluidic devices, the activation of the surface is performed with several parallel channels and leads to activated stripes on the surface. Specific binding to the activated stripes is obtained by taking the microfluidic device off the surface, turning it by 90° and putting it again on the surface. During this manipulation, drying of the biomolecules or cells can take place leading to denaturation. Thus, up to now these methods remain an area with considerable need for innovation and improvement.

The attraction of developing protein arrays is the amount of information that can be obtained as a function of research time and sample quantity. The enormous potential of this microspot technology was demonstrated by DNA chips leading to the decoding of the human genome in far less time than expected. Moreover, from a commercial perspective, protein chips appear to be a highly lucrative market estimated to grow to $500 million by 2006 [22].

### DISCLOSURE OF THE INVENTION

Hence, it is a general object of the invention to provide a method suitable to obtain local functionalization of an array of a plurality of spots with the help of a microfluidic device, that allows the production of an array such that during the whole process no drying of the biomolecules or cells can take place and therefore no denaturation resulting from such drying results.

It is a further object of the invention to provide a microfluidic device for performing such functionalization and a method for its manufacture.

Now, in order to implement these and still further objects of the invention, which will become more readily apparent as the description proceeds, the microfluidic device of the present invention is manifested by the features that it in particular comprises a flow cell part and a chip part together forming at least two crossing, preferably perpendicular, closed channels, said flow cell part forming open channels providing the bottom wall and at least part of the side walls, in particular three walls of said closed channels, said closed channels being connected to at least two, preferably at least three fluid providing means for generating at least two, preferably at least three fluid flows and said closed channels being designed and dimensioned such that the flow of at least two, preferably at least three aqueous fluids streaming through each of said channels is laminar at least until after said crossing of said channels, said chip part forming the top wall and optionally part of said side walls, in particular the fourth wall, of said closed channels and having a surface that is activatable by reaction with an activating molecule.

The surface of the chip part is e.g. such that the activation can be made by

(i) adsorption of an active molecule, or

(ii) desorption of a blocking molecule, or

(iii) chemical change of an inactive functional group to an active functional group.

In case (i) a preferred blocking agent is the resistant PLL-g-PEG which can be removed using acidic cleaning solutions as activating agents. In case (ii) preferred linker molecules include streptavidin, Ni²⁺, DNA, linker peptides or proteins which can either specifically bind to their corresponding ligand on the surface (i.e. biotin, nitrilo triacetic acid (NTA), single stranded DNA, antibody etc.) or can be immobilized using non-specific interactions (such as hydrophobic or electrostatic interaction).

After activation the surface is able to bind the reagents of interest to be arrayed. These include proteins, DNA, peptides, supramolecular assemblies, particles or cells, preferably membrane proteins embedded in vesicles.

In a preferred embodiment, the chip part comprises a number of individual spots laying in the area of the crossing of two of said channels, the maximal number of said individual spots corresponds to the number of possible flows in one direction multiplied by the number of possible flows in crossing, preferably perpendicular direction.

During the use of the flow cells for generating individually functionalized spots or areas it has to be ensured that each of said flows through each of said channels is as broad as the area laying in its flow or broader than the diameter of each of said spots laying in its flow. Please note that in the following description the term area is also applied in the sense of “areas to be generated”.

In a preferred embodiment of the microfluidic device, said device has only two crossing channels, one in each direction.

The flow cell part of the microfluidic device of the present invention preferably is made of a polymer substance, in particular of Polydimethylsiloxane (PDMS), however, it may also be made of glass, metal etc.

The chip part can be of different materials, e.g. of glass, metal, etc. or it may be a wafer, in particular for an embodiment with individual spots. Such a chip suitably comprises m x n spots in the area where two channels cross (crossing area) whereby m and n independently from each other preferably are in the range from 2 to 1000, preferably 10 o 100 in particular m² (or n²) spots, i.e. from 4 to 1000000 spots.

It is not necessary but much preferred that the crossing channels and thus the crossing flows are perpendicular.

In the following description, the invention will be described for two crossing channels. In the case of more than two crossing channels, the following description applies to each of the crossing channels or to each crossing of channels, respectively.

In general, both channels of the microfluidic device are connected to at least 2 fluid inlets (2 fluid inlets in each direction are sufficient for n=m=2), preferably 3 or more fluid inlets. With 3 fluid inlets already many streams can be initialized, e.g. up to 100 streams, however, more inlets are preferred in order to reduce the needed time for initialization. In the case of m+2 or n+2 or less than m or n inlets, in general at least two of the inlets comprise fluids that are not needed for initializing streams. In the case of m+2 or n+2 inlets, the inlets generating the outer or exterior streams, i.e. the streams in direct contact with the side walls of the channels, are filed with non activating or functionalizing fluid, e.g. a buffer solution, since the exterior streams, due to the contact with the side walls, often are not sufficiently laminar. In the case of less than m or n inlets, at least one, preferably at least two of the inlets are filled with not initializing (inert) fluid. In this case, these inlets must be designed such that the breadth of the stream generated by said inlets can be controlled, e.g. such that one inert flow has the breadth of several streams thereby enabling to in a first step initialize one row of spots/areas and in a second step the next row of spots/areas. Only in the case of m and n inlets optionally no inert flow is provided. In this case care has to be taken that also the outside streams are sufficiently laminar.

The advantage of m and n to m+2 and n+2 inlets is that with a minimal number of steps all spots/areas can be finally initialized, namely in that the chip is first subjected to selectively activating flows in one direction and then to functionalizing streams in crossing direction. The disadvantage of such an embodiment is that the space needed for so many inlets in small dimensioned devices is not available. The advantage of only a few inlets is that the space is no problem. However, in this case from several to many initializing steps have to be performed. Thus, dependent on the miniaturization of the device, as many inlets as possible will be provided, preferably from 3 to 100, in particular from 3 to 10.

In a preferred embodiment, the two crossing channels comprise identical numbers of rows of spots/areas to be initialized, in general from 3 to 1000, preferably from 10 to 100 rows each. Since in view of the small dimensions the friction at the walls, in particular the side walls, is critical for the laminar flow the channels in general have a width allowing the generation of 2 more streams than rows are present, or of broader exterior streams, i.e. broader streams in direct contact with the side walls. Such an embodiment ensures that the streams in direct contact with the side walls of the channels are not in contact with the rows of spots or—in other words—that all streams in contact with the rows of spots are laminar.

In view of the small dimensions and the friction at the walls, it is also preferred to have as many rows as possible placed in the crossing of two channels. Thus, in a preferred embodiment of the present invention, the chip has exactly 1 crossing of in particular perpendicular channels.

During the production of the microfluidic device, in order to ensure continuous laminar flow, it is preferred that all inlets are connected to at least one reservoir. In the case of an inlet coupled to several reservoirs it should be ensured that the change from one reservoir to another reservoir can be performed without affecting the laminar flows. It is also possible to have several inlets coupled to one and the same reservoir if more than one row of spots/areas shall be subjected to the same flow. Dependent on the actual dimensions, it is possible and in general sufficient to induce the flows and to determine their width by choosing appropriate levels between the fluid providing reservoirs and the fluid collecting reservoir(s). Alternatively means to apply pressure or to reduce pressure may be provided. However, the connection of the device to such means complicates the device and therefore, the generation of appropriate flows by adjusting the levels of the reservoirs is preferred.

If a finally produced microfluidic device is used in a test, either all or part of the inlets can be coupled to a reservoir that contains the test fluid. Since the chip may remain within the microfluidic device, any risk of drying out and thus the risk of generating artifacts can be minimized.

One critical place for keeping the streams laminar is at the crossing of the channels. In order to minimize said problem at least one, preferably two valves per channel may be provided to prevent a broadening of the streams at said crossing. Preferably said valves are positioned as close as possible to the crossing.

A suitable width of a laminar fluid flow is between 0.5 to 4 μm. Good results are obtained with widths of about 2 μm for a chip with spots having a diameter of 1 μm and a distance between two spots of also 1 μm. It is, however possible and preferred that the flow width is even smaller, e.g. around 1 μm for chips with spots of a diameter of about 0.5 μm and distances between the spots of also about 0.5 μm. In the case of the generation of areas, i.e. for functionalization of a surface with no prepatterning, the flow with corresponds to the area width.

In order to ensure the laminarity of the streams, they may first be controlled by adding a coloring agent prior to the addition of the desired reagent.

The method of the present invention is suitable for producing a microfluidic device with as much individually functionalized spots as there are spots within one crossing, in general at least four individually functionalized spots, in particular from 100 to 10000 spots. The maximal number of individually functionalized areas is limited by the minimal width of each laminar flow in each direction. For producing a microfluidic device of the present invention, first a flow cell part has to be sealed to a chip part, in particular by applying pressure.

A flow cell part, in particular a flow cell part for use in the inventive method may suitably be produced in that a matrix with protruding flow cell design is provided, in that a polymer is applied to said matrix such that it casts said flow cell design, in that said polymer is cured and in that said polymer is removed from said matrix.

A matrix, in particular a matrix for being used in the above described flow cell part production, may suitably be produced in that a UV and solvent stable flat surface, in particular a silicon wafer, is covered with a photoresist, in that a mask with the desired flow cell design is placed over said photoresist coated surface, in that said photoresist covered surface is irradiated such that said photoresist withstands removing in the region of said flow cell design, and in that the photoresist outside said flow cell design is removed.

A chip part may be produced by providing a suitable surface. This may be done by using a material with a surface that is suitable for adsorption of molecules, or a material may be coated with a respective surface, or suitable molecules allowing subsequent activation may already be adsorbed.

A preferred MAPL chip, in particular a MAPL chip for being used in the inventive method may suitably be produced by a method comprising providing a substrate coated with a cured photoresist, wherein said photoresist can be destroyed by UV irradiation, placing a mask comprising the desired number and shape of spots over said photoresist coated surface, irradiating the photoresist over the spots, removing the irradiated photoresist, applying a protein-to-surface anchoring molecule, removing the photoresist from the areas between the spots, and filling the areas between the spots with protein repelling molecule.

Preferred protein-to-surface anchoring molecules and preferred protein repelling molecules comprise functionalized and unfunctionalized poly(L-lysine)-g-polyethyleneglycole (PLL-g-PEG), respectively.

A more detailed, preferred method for producing a microfluidic device with individually functionalized spots/areas comprises the steps of

(i) applying laminar streams of aqueous fluids comprising at least one activating stream over the crossing in a first direction to selectively activate at least one row of spots/areas,

(ii) directing as many laminar streams as rows of spots/areas over said crossing in a second, crossing direction, preferably in a second direction perpendicular to said first direction, in order to generate one row of individually functionalized spots/areas

(iii) repeating steps (i) and (ii) until all spots/areas are individually functionalized.

The present invention also comprises individually functionalized chips outside a microfluidic device, however, preferably within a microfluidic device to ensure that no artifacts due to drying out are generated. The chips are characterized by the presence of individually functionalized spots/areas, whereby in the case of spots, the surface between said spots is covered by a protein (or other functionalizing molecules) resistant adlayer, i.e. an adlayer to which proteins (or other functionalizing molecules) do not adhere.

The microfluidic devices of the present invention may be designed with or without a laminar basic flow. An embodiment of such a device without basic flow is now further described.

### BRIEF DESCRIPTION OF THE DRAWINGS

The invention will be better understood and objects other than those set forth above will become apparent when consideration is given to the following detailed description thereof. Such description makes reference to the annexed drawings, wherein:

FIG. 1 shows the working principle of the local functionalization of a prepatterned surface of an array of 9 spots in a microfluidic device.

FIG. 2 shows a suitable design of a microfluidic device with two perpendicular crossing channels to enable the laminar streams as shown in FIG. 1, whereby in this embodiment both channels have the equivalent number of inlets as they have rows of spots.

FIG. 3 shows the design of FIG. 2 with indicated flows in one direction.

FIG. 4 shows how more than 3 rows can be functionalized with 3 inlets only.

FIG. 5 is a schematic presentation of a chessboard pattern obtainable with the method of the present invention.

### MODES FOR CARRYING OUT THE INVENTION

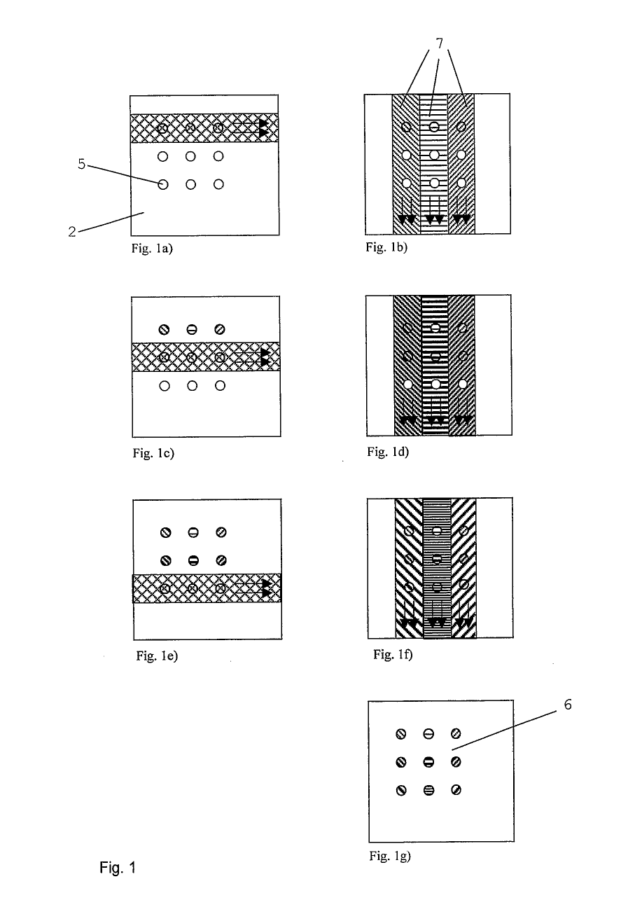

The primary intent of the present invention is to provide a chip 2 with individually functionalized spots/areas 5. The working principle of the local functionalization is shown in FIG. 1 for an array of 9 spots 5. The number of 9 spots 5 (and the resulting number of streams 7) is coincidentally chosen and can be varied, especially in the scope of the appended claims.

Although the Figures show spots 5, the following description is as well applicable to areas.

According to FIG. 1, the spots 5 are arranged in an array of 3×3 spots. In a first step an activating laminar stream 7 is led over the chip 2 activating the first row of spots (FIG. 1a)).

Thereafter these three activated spots are functionalized by three laminar streams 7, which flow perpendicular to the activating stream over the array (FIG. 1b)).

These two steps are repeated for the second and third row of spots on the MAPL—chip (FIG. 1c)-FIG. 1f)). The only change consists in using different reagents for the functionalizing streams.

Thus a square of 9 differently labelled spots 5 is obtained (FIG. 1g)).

It has been found that not each design of the microfluidic device is identically suited. It is e.g. preferred that the flow cell 1 has two crossing channels 3, 4 that are perpendicular as e.g. shown in FIGS. 1 to 3. Secondly, if not too many rows are present, or if the spots/areas 5 are not too closely positioned, each of these channels has the equivalent number of inlets as it has rows of spots/areas or two more than this number to ensure that all activating/functionalizing flows are distant from the side walls and thus more perfectly laminar.

One possible design for a flow cell suitable for the production of an array of 3×3 points is shown in FIG. 1. For such an embodiment, the dimensions of the lengths L₁ to L₃ and the diameters D₁ to D₃ may be as shown in Table 1 below.

TABLE 1

| | general | preferred | |
|---|---|---|---|
| | range | range | preferred relation between |
| Dimension | [μm] | [μm] | dimensions |
| L₁ | 1-50000 | 10-1000 | L₁ = L₃ < L₂ |
| L₂ | 1-50000 | 10-1000 | |
| L₃ | 1-50000 | 10-1000 | |
| D₁ | 10-50000 | 100-1000 | D₁ > D₂ = D₃ |
| D₂ | 1-2000 | 10-1000 | |
| D₃ | 1-2000 | 10-1000 | |

In addition to a preferred design also some materials are preferred. A preferred material for the flow cell is polydimethylsiloxane (PDMS). The following materials are preferably used to produce the desired surface of the MAPL-chip:

A resistant background (e.g. PLL-g-PEG), spots which are also resistant to the non-specific adsorption of the molecules of interest and present suitable ligands which can be activated using an activating agent. After the activation of the spots by flowing the activating agent from one direction, the molecules of interest can be specifically coupled to the spots by flowing from the other direction.

PLL-G-PEG is a polycationic protein resistant copolymer, that adsorbs spontaneously from aqueous solutions onto negatively charged surfaces such as oxides of niobium, titanium, silicon and indium tin oxide. An example for such a polymer is PLL(20)-g(3.4)-PEG(2)

For dissolving PLL-g-PEG and functionalized PLL-g-PEG, e.g. PLL-g-PEG-biotin, Hepes 2 (4-(2-hydroxyethyl)pipera-zine-1-ethanesulfonic acid) can be used. A suitable solution is e.g. 150 mM Hepes in ultra pure water with an adjusted pH of 7.4. HEPES powder is e.g. obtainable from Fluka.

Preferred wafers for the MAPL chip production are e.g. 4-inch Pyrex 7740 wafer from SensorPrep, Nb₂O₅ coated with a dc-magnetron 7600 from Leybold.

The first step in manufacturing the microfluidic device is the production of the flow cell, e.g. a PDMS flow cell 1, and the chip part, e.g. the MAPL Chip 2.

One possible process for the production of a microfluidic device made of a molded flow cell and a prepatterned chip is composed of the following subprocesses,

1. Mould production by photolithography

2. Replica molding with PDMS

3. Prepatterning

4. MAPL Patterning

5. Assembly of the microfluidic device.

In this process, subprocesses 1 and 2 concern the production of the flow cell 1, subprocesses 3 and 4 the chip 2 production and subprocess 5 the assembly of the microfluidic device

1. Mold Production

For the production of the mould the use of photolithographic technique is preferred. A suitable mould material or use in lithographic techniques in general is a wafer. On the chosen mold material a photoresist is homogeneously applied by e.g. spincoating and then prebaked. In a next step the coated wafer and a photomask (e.g. a foil showing the design of the desired flow cell glued to a glass plate) are installed in a mask aligner where the photoresist then is exposed to UV light through the mask for a time suitable to at least start a crosslinking reaction in the photoresist. Said crosslinking reaction may be finished during a postbake. The desired pattern is then obtained by developing the wafer in suitable solutions. In this step the photoresist not exposed to UV light is solubilised and removed.

2. Replica Molding

Replica molding is the process of producing a polymer replica from a structured master. This was carried out by mixing a polymer precursor and a curing agent at a suitable ratio. If the mixture comprises bubbles, e.g. generated during mixing, it is preferred to degas it in a vacuum to get rid of them. The mixture is then cast over the mould and finally cured at a suitable temperature for a suitable time, e.g. for PDMS at about 80° C. for about 24 hours. Undercuring is known to possibly lead to the release of small molecular weight oligomers and to reduced mechanical stability of the polymers. Therefore it should be ensured that the polymer is fully cured. After curing the polymer replica are peeled off the mould.

3. MAPL-Chip; Prepatterning

The function of the MAPL-chip in the microfluidic device is on the one hand the provision of a surface patterning on which protein binding can take place on well defined areas (spots 5) and on the other hand to seal the channels 3, 4 of the polymer flow cell 1. The production relies on a combination of an initial top-down photolithographic step and a following bottom up molecular assembly step. The first step (prepatterning) defines the pattern geometry and the second step (MAPL-patterning) introduces the biochemical function.

The process of the prepatterning—as already addressed above—is also a photolitographic process. A suitable base material, in general a wafer, in particular a Nb₂O₅ coated wafer, is coated with a positive photoresist by means of e.g. spincoating, and then subjected to a suitable baking. An illumination step is then carried out e.g. on a mask aligner. In the case of a positive photoresist, the illumination does not lead to a crosslinking of the photoresist but to a destruction of the chemical bonds of the exposed parts. By subsequently applying a developer bath the photoresist exposed to UV light can be removed. The prepatterning of the MAPL-chip results in a chip with photoresist free spots in an otherwise photoresist coated surface. If desired, the wafer may be cut to chips of desired size prior to further treatments.

4. MAPL-Patterning

In a first step of the MAPL patterning, the chips 2 are treated with a polymer which is resistant to non-specific adsorption but can be activated to specifically adsorb the molecule of interest, e.g. a functionalized PLL-g-PEG copolymer such as PLL-g-PEG-biotin.

Subsequently the remaining photoresist preferably is removed from the samples and in a last step of the MAPL-patterning the now bare surfaces between the spots 5 are backfilled with a not functionalized protein resistant polymer, e.g. not-functionalized PLL-g-PEG. Therefor a suitable amount, e.g. one drop of protein resistant polymer solution is applied on the chip for a suitable time, e.g. 15 to 60 minutes giving the final MAPL-chips.

In all these steps suitable cleaning methods can be applied to the equipment used and the wafers/chips and usually are applied. Such cleaning methods comprise methods usually applied in clean room technology, e.g. cleaning with Piranha solution, rinsing with ultra pure water (e.g. Millipore), optionally in an ultrasound bath, drying under a nitrogen stream, cleaning in an oxygen plasma (e.g. PDC-23G from Harrick Scientific Corporation) etc.

5. Assembly of the Microfluidic Device

To obtain a working microfluidic device the polymer replica must be sealed to a flat object, for example a cover slip or a MAPL-chip. Due to a small contacting surface and a lot of mechanical stress from the weight of the tubes the reversible sealing by Van der Waals forces in general is insufficient. Also irreversible sealing may not always entirely satisfy. Reliably good results are, however, obtained by sealing the polymer replica to a coverslip or MAPL chip by applying pressure.

A simple device for applying suitable pressure is e.g. a sealing device comprising two parallel plates releasably connected together such that in released state the flow cell can be arranged between said plates. By reducing the distance between the parallel plates, a desired pressure may be applied to the microfluidic device thereby sealing the flow cell 1 to the coverslip or MAPL chip 2. The releasable fixation can e.g. be achieved by screws or clamps.

The method of sealing by pressure proved to be fully satisfying.

For connecting the polymer replica to the fluid reservoir, at the ends of the channels of the polymer replica holes to enable fluid flow access to the flow cell (fluid flow access holes 8, diameter: D₃) are provided, suitably by punching. The flow cell is then placed on a cover slip or MAPL-chip and then sealed such that the area whereon the functionalization shall be made is positioned in the channel crossing area 6.

If the sealing is done with the sealing device, in order to get access to the flow cell 1, or rather the fluid flow access holes 8, bores, preferably bores provided with hose couplings, are provided in one of the parallel plates of the sealing device. The flow cell is then placed between the parallel plates of the sealing device so that the bores or hose couplings, respectively, lay above the fluid flow access holes 8.

The flow cell is then connected to the surrounding device, which comprises all the tubings and valves needed to initiate and stop the laminar fluid flows.

By applying suitable flows, the rows of spots of the MAPL chip 2 in the microfluidic device can be individually addressed thereby enabling the individual functionalization of each spot 5 on the MAPL chip 2. In general this is done by first activating at least one of the rows in one direction and then applying crossing streams to the chip 2 such that the functionalization is only obtained on the spots 5 in the previously activated rows (see FIG. 1).

A possible application of the micro arrays of the present invention is in micro-immunoassays in which e.g. an array of different capture antibodies such as biotinylated antibodies is produced and subsequently exposed to a biological sample. Analyte proteins bind to the immobilized capture agents and are then detected by fluorescence, luminescence etc.

The invention is now further described for one specific embodiment of a microfluidic device and some possible applications of inventive microfluidic devices.

### EXAMPLES

1. Production of the Flow Cell

1.1. Mould Production

For the production of the mould photolithographic technique was used. In this step a 4-inch <110> silicon wafer from Wafernet GmbH, was cleaned and dried for 10 min in a plasma cleaner (300E from TePla). On this dry wafer 3 ml of photoresist (SU-8 50, MicroChem Company) was homogeneously applied by spincoating (max. speed: 1500 rpm, spincoater: RC 5 GYRSET from Karl Süss). Then the prebake was performed. Therefor the wafer was placed on a 50° C. warm hot plate for 5 min. The hot plate was then heated up to 100° C. and held at this temperature for 60 min. In the next step the wafer and the photomask (foil showing the design of the flow cell, 64′000 dpi, from jdphoto glued to a glass plate) were installed in a mask aligner (MA6/BA6 from Karl Süss), where the photoresist was exposed to UV light through the mask for 44.4 sec to apply 400 J/cm 2. This exposure to UV light started a crosslinking reaction in the photoresist, which was finished during a postbake (5 min at 60° C., then heated up to 95° C., held at 95° C. for 45 min). The pattern was obtained by developing the wafer in different solutions. Thereby the photoresist not exposed to UV light was solubilised first in a GBA developer for 2 min, in a PGMEA developer for 2.5 min and finally in a second and purer PGMEA developer bath for 1 min. By rinsing the wafer afterwards in isopropanol and drying it with nitrogen the final mould was obtained. The height of the mould was found to be around 90 μm as measured with a proflilometer (P10 from Tencor). After production the moulds were controlled with a light microscope. It was found that they showed cracks. Variation of the process parameters of the prebake and the postbake, the developing and the illumination time did not result in a crack free mould. However, since these cracks were not situated on the surfaces of the photoresist, they did not influence the quality of the flow cell. Thus the production parameters are not critical.

1.2. Replica Molding

Replica molding was carried out by mixing PDMS (Sylgar 184, Dow Corning) precursor and curing agent at a ratio of 10:1. Thereafter the mixture was degassed in vacuum to get rid of the air bubbles generated during mixing. The mixture was then cast over the mould and finally cured at 80° C. for 24 hours. In order to avoid undercuring that is known to affect the release of small molecular weight oligomers and mechanical stability of PDMS, the PDMS was cured much longer then proposed in the data sheet from Dow Corning. After curing the PDMS replica could easily be peeled off the mould.

2. Production of the MAPL-Chip

2.1. Prepatterning

A Nb₂O₅ coated wafer was dried on a hot plate (Goller Reinraumtechnik) for 2 min at 115° C. Then 1.8 ml of photoresist (S1818, Shipley) were applied on the wafer and spincoated for 40 sec. (speed: 4000 rpm, acceleration: 4000 rpm/s). The spincoating was followed by a soft bake (temperature: 115° C. for 2 min). An illumination step was then carried out on a mask aligner (MA6 from Karl Süss, lamp power: 500 Watt, illumination time: 7-10 sec). For this positive photoresist the illumination does not lead to a crosslinking of the photoresist but a destruction of the chemical bonds of the exposed parts. In the adjacent developer bath the photoresist exposed to UV light was then removed. For the developer bath a mixture of water and Microposit 315 developer at a ratio of 5:1 was used. The developing lasted 45 sec and was followed by an additional water bath to removed the developer from the mould. The prepatterning of the MAPL-chip resulted in a chip with photoresist free spots in an otherwise photoresist coated surface.

Before the MAPL-patterning was performed the wafer was cut in 2×9 cm pieces with a wafer-dicing machine (ESEC, Switzerland).

2.2. MAPL-Patterning

In a first step the 2×2 cm chips were cleaned. Therefor they were placed vertically in a glass beaker which was previously cleaned with Piranha solution. The beaker was filled with ultra pure water (Millipore) and placed in the ultrasound bath for 5 min. Thereafter the chips were dried under a nitrogen stream and then cleaned in an oxygen plasma (PDC-23G from Harrick Scientific Corporation) for 10 sec to remove residual organic contaminants. After the plasma treatment the samples were placed on a parafilm in the flow box and a drop of PLL-g-PEG-biotin (0.1 mg/ml in Hepes 2) was applied onto the samples for 40 min. The samples were then rinsed with ultra pure water and dried under a nitrogen stream.

Subsequently the photoresist was removed from the samples. Therefor NMP (N-methyl-pyrrolidone for peptide synthesis from Fluka) was flushed over them for 5 sec. The samples were then vertically placed in a Piranha solution-cleaned beaker filled with NMP and subsequently ultrasonicated for 2 min. The NMP in the beaker was replaced by fresh NMP and the samples were ultrasonicated for another 2 min. Then they were transferred to a new beaker filled with a mixture of NMP and ultra pure water at a ratio of 1:1 and sonicated for 1 min. Subsequently they were rinsed in an agitated bath of ultra pure water for 5 min. After a final rinse with ultra pure water they were dried under the nitrogen stream.

In the last step of the MAPL-patterning the bare surfaces of the samples between the spots were backfilled with PLL-g-PEG. Therefor the samples were placed on a parafilm in the flow box and a drop of PLL-G-PEG solution (0.1 mg/ml in Hepes2) was applied on them for 40 min. After a final rinse with ultra pure water and subsequent drying under a nitrogen stream the final MAPL-chips were obtained.

3. Assembly of the Microfluidic Device

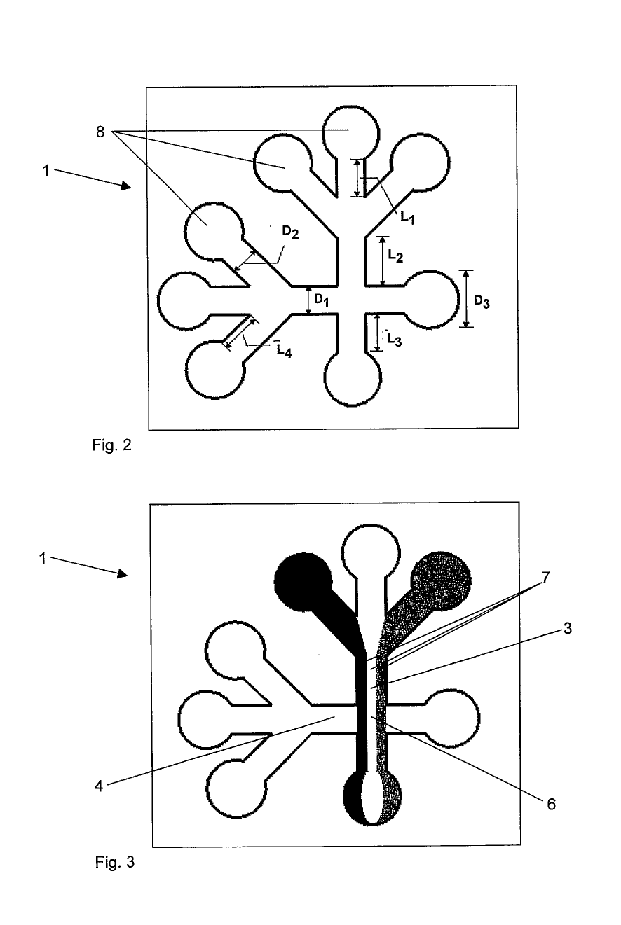

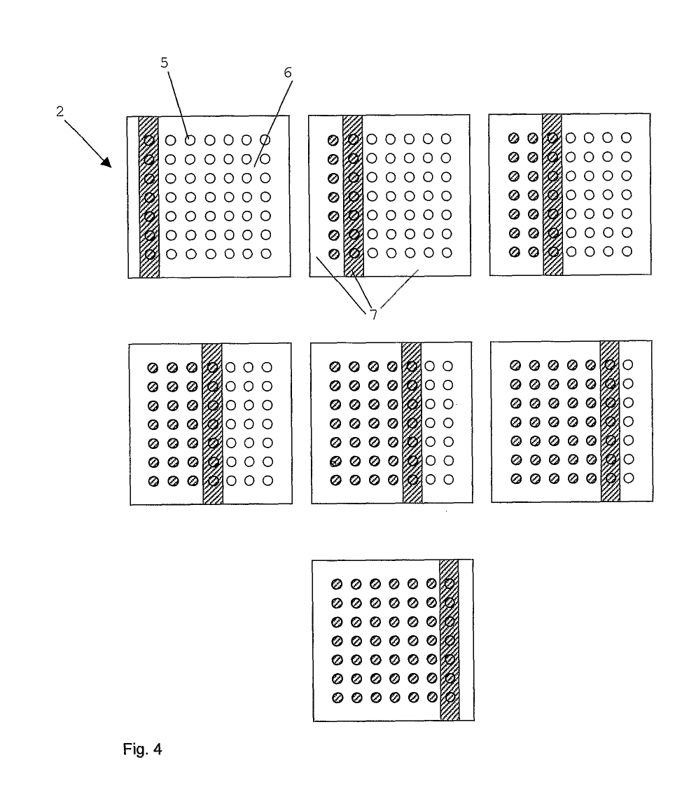

For connecting the PDMS replica to the fluid reservoir, at the ends of the channels of the PDMS replica holes (diameter D₃ in FIG. 2=3 mm) were punched. The flow cell was then cleaned with ultra pure water, dried with nitrogen and exposed to air plasma for 30 sec to render the surface hydrophilic. Subsequently the flow cell was placed on a cover slip or MAPL-chip and then installed in the sealing device.

In order to get access to the flow cell, or rather the punched holes, bores, preferably bores provided with hose couplings, were provided in one of the parallel plates of the sealing device. The flow cell was placed in the sealing device so that the bores or hose couplings, respectively, lay above the punched holes.

The flow cell was then connected to the surrounding device, which consisted of all the tubings and valves needed to initiate and stop the laminar fluid flows.

4. Determination and Investigation of the Flow Behaviour

4.1. Initial Filling of the Flow Cell

In order to investigate the flows, the flow cell and the surrounding device were both placed on a microscope. The whole microfluidic device was then filled up with water or buffer from the outlet side with a syringe. Then the filling was checked with the microscope to ensure that no air bubbles remained in the channels.

4.2. Flow Rate Measurements

The microfluidic device was calibrated by measuring the flow rate in function of the height difference between the water level in the fluid stream genrating beaker and the waste beaker at the outlet. Therefor the height of the water level in the fluid stream generating beaker was maintained at 2 cm and the height of the table carrying said fluid stream generating beaker was varied. The weight of water flowing through the microfluidic device during 120 sec was measured and the flow rate in ml/h was calculated. This resulted in a microfluidic device specific curve enabling the selection of the appropriate height for a specific flow desired.

The results of the flow rate measurements proved that the obtained curve is linear as expected.

4.3. Function Test with Food Coloring

By this test, the variation of the width of the middle stream in dependence of the difference of the water level in the middle stream generating beaker and the external streams generating beakers could be shown. In a first experiment the water level of the external stream generating beakers was maintained at a height of 2 cm and the water level of the beaker generating the middle stream was varied in height by adding or removing water. The changes in the streams were studied in a light microscope. It was found that the width of the middle stream can easily be varied by increasing or decreasing the water level in the beaker generating said middle flow.

In the used embodiment of the microfluidic device no valves were provided in the channel crossing area, so that extension of the flow in this crossing area was observed. Therefore, the stream width was determined within the channel.

The observation that the flows widen up in the cross section of the channels is—without intending to be bound to this interpretation in any way—attributed to a pressure loss in the closed perpendicular channel which is possibly due to expansion of the tubes and can be eliminated by positioning valves closer to the crossing.

4.4. Function Test with Fluorescently Labeled Proteins

4.4.1 Production of One Pair of Crossing Stripes

In a first experimental series simple structures as for example two perpendicular stripes of adsorbed fibrinogen were tried to obtain.

The experiments were performed with fibrinogen Alexa Fluor 488 on the final setup by using gravitational flow. In a first step the tubes were filled with the required protein solution. Then the tubes filled with protein were placed in a beaker filled with Hepes 1. The difference in height of the buffer level of the beaker generating the protein flow and the waste beaker at the outlet was 12.5 cm. The buffer level of the beakers generating the buffer flow was a bit heightened compared to the buffer level of the protein flow generating beaker. This was done to prevent an overlapping of the different stripes of adsorbed proteins in one channel. After the adjustment of the buffer level in the beakers the flows through the flow cell were started by opening the valves of the surrounding device. After the whole amount of reagent had run through the flow cell the following buffer flow was continued to rinse the device. After switching to the perpendicular channel the procedure was repeated.

The geometries were analysed using a fluorescent microscope.

These tests proved that with the microfluidic devices of the present invention stable laminar streams can be obtained for the period of time of the experiment.

4.4.2 Chessboard Pattern

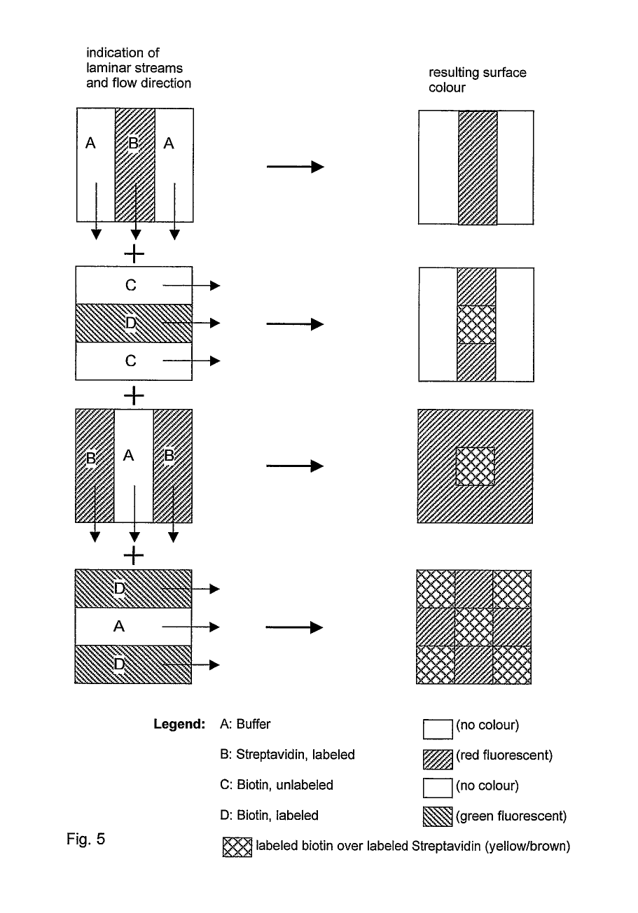

A second experimental series was made with the goal to produce a chessboard pattern with streptavidin Alexa Fluor 633, biotin 4-fluorescein and biotin IgG on a PLL-g-PEG-biotin coated cover slip or a MAPL-chip (see FIG. 5). By attempting this result the feasibility of the main purpose, namely to functionalize nine spots on a MAPL-chip differently, could be proved. The red stripes/squares on the surfaces in FIG. 5 show, where the fluorescent streptavidin has bound to the surface and the yellow/brown color indicates the areas where fluorescent biotin (green) bound to the fluorescent streptavidin (red). After the tests were performed the samples were analysed with a confocal laser scanning microscope (LSM 510 from Zeiss).

As desired a chessboard pattern could be obtained with the spots marked as “red” in FIG. 5 representing the signal obtained from the streptavidin Alexa Fluor 633, and the ones marked as “yellow/brown” representing the signal from the sum of both signals.

While there are shown and described presently preferred embodiments of the invention, it is to be distinctly understood that the invention is not limited thereto but may be otherwise variously embodied and practiced within the scope of the following claims.

### REFERENCES

[1] McDonald J. C., Duffy D. C., Anderson J. R., Chiu D. T., Wu H. K., Schueller O. J. A., Whitesides G. M., Production of microfluidic systems in poly(dimethylsiloxane). Electrophoresis. 2000;21:27-40
[2] Whitesides G. M., Emanuele O., Shuichi T., Xingyu Jiang a., Ingber D. E., Soft Lithography in Biology and Biochemistry. Annu. Rev. Biomed. Eng. 2001;3:335-375
[3] Ng Lee J., Park C., Whitesides G. M., Solvent Compatibility of Poly(dim-ethylsiloxane)-based Microfluidic Devices. Analytical Chemistry. 2003;75:6544-6554
[4] Madou M. J., Fundamentals of microproduction the science of miniaturization. 2nd ed. Boca Raton, Fla.: CRC Press, 2002:723
[5] Xia Y. N., Whitesides G. M., Soft lithography. Angew Chem Int Edit. 1998;37:551-575
[6] Duffy D. C., McDonald J. C., Schueller O. J. A., Whitesides G. M., Rapid prototyping of microfluidic systems in poly(dimethylsiloxane). Analytical Chemistry. 1998;70:4974-4984
[7] Li C. W., Cheung C. N., Yang J., Tzang C. H., Yang M. S., PDMS-based microfluidic device with multi-height structures fabricated by single-step photolithography using printed circuit board as masters. Ana-lyst. 2003;128:1137-1142
[8] Jo B. H., Van Lerberghe L. M., Motsegood K. M., Beebe D. J., Three-dimensional micro-channel production in polydimethylsiloxane (PDMS) elastomer. Journal of Microelectromechanical Systems. 2000;9:76-81
[9] McDonald J. C., Metallo S. J., Whitesides G. M., Production of a configurable, single-use microfluidic device. Analytical Chemistry. 2001;73:5645-5650
[10] Fu A. Y., Chou H. P., Spence C., Arnold F. H., Quake S. R., An integrated microfabricated cell sorter . Analytical Chemistry. 2002;74:2451-2457
[11] Walker G. M., Ozers M. S., Beebe D. J., Insect cell culture in microfluidic channels. Biomedical Microdevices. 2002;4:161-166
[12] Bernard A., Michel B., Delamarche E., Micromosaic immunoassays. Ana-lytical Chemistry. 2001;73:8-12
[13] Pawlak M., Schick E., Bopp M. A., Schneider M. J., Oroszlan P., Ehrat M., Zeptosens' protein microarrays: A novel high performance microarray platform for low abundance protein analysis. Proteomics. 2002;2:383-393
[14] Templin M. F., Stoll D., Schrenk M., Traub P. C., Vohringer C. F., Joos T. O., Protein microarray technology. Drug Discovery Today. 2002;7:815-822
[15] Zhu H., Bilgin M., Bangham R., Hall D., Casamayor A., Bertone P., Lan N., Jansen R., Bidlingmaier S., Houfek T., Mitchell T., Miller P., Dean R. A., Gerstein M., Snyder M., Global analysis of protein activities using proteome chips. Science. 2001;293:2101-2105
[16] Wilson D. S., Nock S., Functional protein microarrays. Current Opinion in Chemical Biology. 2002;6:81-85
[17] MacBeath G., Schreiber S. L., Printing proteins as microarrays for high-throughput function determination. Science. 2000;289:1760-1763
[18] Martin B. D., Gaber B. P., Patterson C. H., Turner D. C., Direct protein microarray production using a hydrogel “stamper”. Langmuir. 1998;14:3971-3975
[19] Silzel J. W., Cercek B., Dodson C., Tsay T., Obremski R. J., Mass-sensing, multianalyte microarray immunoassay with imaging detection. Clin. Chem. 1998;44:2036-2043
[20] Morozov V. N., Morozova T. Y., Electrospray deposition as a method to fabricate functionally active protein films. Analytical Chemistry. 1999;71:1415-1420
[21] Rowe C. A., Scruggs S. B., Feldstein M. J., Golden J. P., Ligler F. S., An array immunosensor for simultaneous detection of clinical analytes (vol. 71, p. 433, 1999). Analytical Chemistry. 2003;75:1225-1225
[22] Mitchell P., A perspective on protein microarrays. Mature biotechnology. 2002;20:225-229

1. A microfluidic device comprising a flow cell part (1) and a chip part (2) together forming at least two crossing, preferably perpendicular, closed channels (3, 4), said flow cell part (1) forming open channels providing the bottom wall and at least part of the side walls, in particular three walls of said closed channels (3, 4), said closed channels (3, 4) being connected to at least three fluid providing means for generating at least three fluid flows (7) and said closed channels (3, 4) being designed and dimensioned such that the flow (7) of at least three aqueous fluids streaming through each of said channels (3, 4) is laminar at least until after said crossing of said channels (6), said chip part (2) forming the top wall and optionally part of said side walls, in particular the fourth wall, of said closed channels (3, 4) and having a surface that is activatable by reaction with an activating molecule.

2. The microfluidic device of claim 1, wherein the surface is such that the activation can be made by
(i) adsorption of an active molecule, or
(ii) desorption of a blocking molecule, or
(iii) chemical change of an inactive functional group to an active functional group.

3. The microfluidic device of claim 1, wherein said chip part (2) comprises a number of individual spots (5) laying in the area of the crossing (6) of two of said channels (3, 4), the maximal number of said individual spots (5) corresponding to the number of possible flows (7) in one direction multiplied by the number of possible flows (7) in crossing, preferably perpendicular direction, preferably a Molecular Assembly Patterning by Lift-off (MAPL) chip.

4. The microfluidic device of claim 1, wherein the flow cell part (1) is of a polymer substance, in particular Polydimethylsiloxane (PDMS).

5. The microfluidic device of claim 1, wherein the chip part (2) in one crossing area (6) comprises m×n spots (5) whereby m and n independently from each other are in the range from 10 to 100, in particular m=n spots (5).

6. The microfluidic device of claim 1, wherein each of the channels (3, 4) is connected to 3 to 1000, in particular to 3 to 100, much preferred to 10 to 100 fluid inlets.

7. The microfluidic device of claim 1, whereby the chip has exactly 1 crossing of preferably perpendicular channels (3, 4).

8. The microfluidic device of claim 1, wherein each channel has a separate inlet for each fluid.

9. The microfluidic device of claim 1, said device comprising channels (3, 4) having a width of about 1.5 mm and three inlets per channel and a length of 2.5 mm of combined stream until the crossing (6).

10. The microfluidic device of claim 1, wherein the spots (5) have a diameter of 0.5 urn to 2 urn and the distance between two spots (5) is about 1 urn.

11. The microfluidic device of claim 1, comprising at least two individually functionalized spots (5), in particular as much individually functionalized spots (5) as there are spots (5) within one crossing (6).

12. The microfluidic device of claim 1, wherein the laminar streams are directly generated, i.e. without using a continuous base stream.

13. A method for producing a microfluidic device of claim 1, wherein a flow cell part (1) is sealed to a chip part (2), in particular by applying pressure.

14. A method for producing a microfluidic device with individually functionalized spots/areas (5) comprising
(i) applying laminar streams of aqueous fluids comprising at least one activating stream over the crossing (6) in a first direction to selectively activate at least one row of spots/areas (5),
(ii) directing as many laminar streams as rows of spots/areas (5) over said crossing (6) in a second, crossing direction, in particular in a second direction perpendicular to said first direction, in order to generate one row of individually functionalized 10 spots/areas (5)
(iii) repeating steps (i) and (ii) until all spots/areas (5) are functionalized.

15. The method of claim 14, wherein each of said flows (7) through each of said channels (3, 4) is as 15 broad as the width of each of said areas (5) or broader than the diameter of each of said spots (5) laying in its flow (7).
